(19) United States
(12) Patent Application Publication
(10) Pub. No.: US 2025/0322106 A1
(43) Pub. Date: Oct. 16, 2025

(54) MEMORY DEVICE SECURITY THROUGH DISABLEMENT OF FUSE BLOWS

(71) Applicant: MICRON TECHNOLOGY, INC., Boise, ID (US)

(72) Inventors: Seth Aaron Eichmeyer, Boise, ID (US); John Gonzales, Boise, ID (US); Matthew Jenkinson, Boise, ID (US); Christopher Gordon Wieduwilt, Boise, ID (US)

(21) Appl. No.: 19/083,932

(22) Filed: Mar. 19, 2025

Related U.S. Application Data
(60) Provisional application No. 63/634,632, filed on Apr. 16, 2024.

(51) Int. Cl. G06F 21/78; G11C 29/10

(52) U.S. Cl. CPC G06F 21/78; G11C 29/10

(57) ABSTRACT

A memory device includes a memory array; a plurality of fuses; a disabling fuse; and control logic, operatively coupled with the plurality of fuses and the disabling fuse, to perform operations during manufacturing of the memory device, the operations including: determining whether the plurality of fuses are programmed; and responsive to determining that the plurality of fuses are programmed, blowing the disabling fuse to disable a blow functionality, wherein the blow functionality is triggered by a subsequent blow command to blow the plurality of fuses.

### RELATED APPLICATIONS

This application claims the benefit of U.S. Provisional Patent Application No. 63/634,632 filed Apr. 16, 2024, entitled “MEMORY DEVICE SECURITY THROUGH DISABLEMENT OF FUSE BLOWS”, the contents of which are incorporated by reference in its entirety herein.

### TECHNICAL FIELD

Embodiments of the disclosure relate generally to memory sub-systems, and more specifically, relate to memory device security through disablement of fuse blows.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1A illustrates an example computing environment that includes a memory sub-system in accordance with some embodiments of the present disclosure.

FIG. 1B illustrates a block diagram of the memory sub-system of FIG. 1A in accordance with some embodiments of the present disclosure.

FIG. 2 illustrates an example of a command performing the blow functionality and the disablement of the blow functionality in accordance with some embodiments of the present disclosure.

FIG. 3 illustrates a flow diagram of an example method to implement, during the manufacture of the memory device, the disablement of fuse blows in accordance with other embodiments of the present disclosure.

FIG. 4 illustrates a flow diagram of an example method to implement, during the operation of the memory device, the disablement of fuse blows in accordance with other embodiments of the present disclosure.

FIG. 5 is a block diagram of an example computer system in which embodiments of the present disclosure may operate.

### DETAILED DESCRIPTION

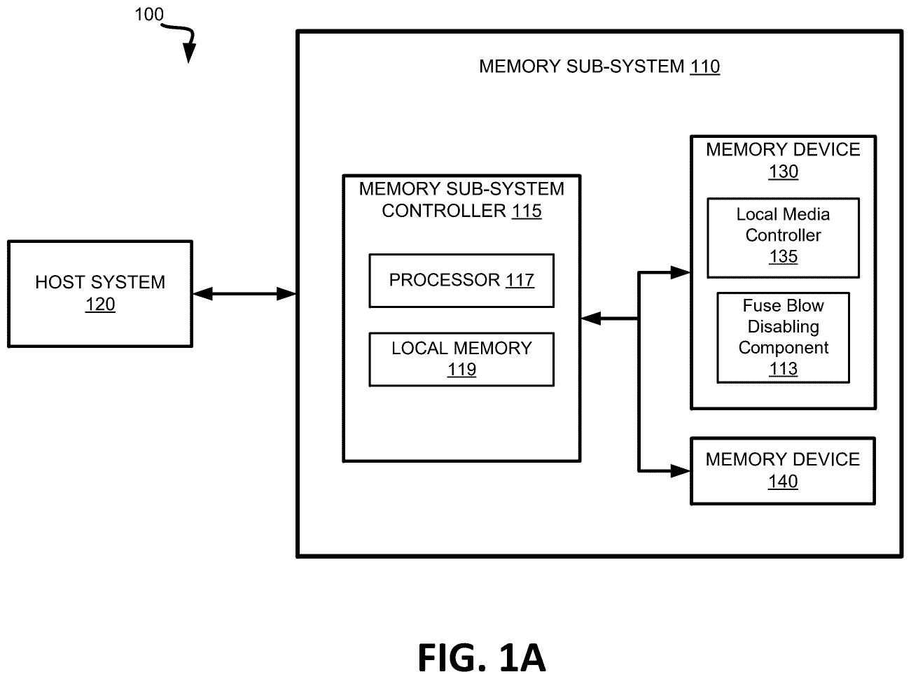

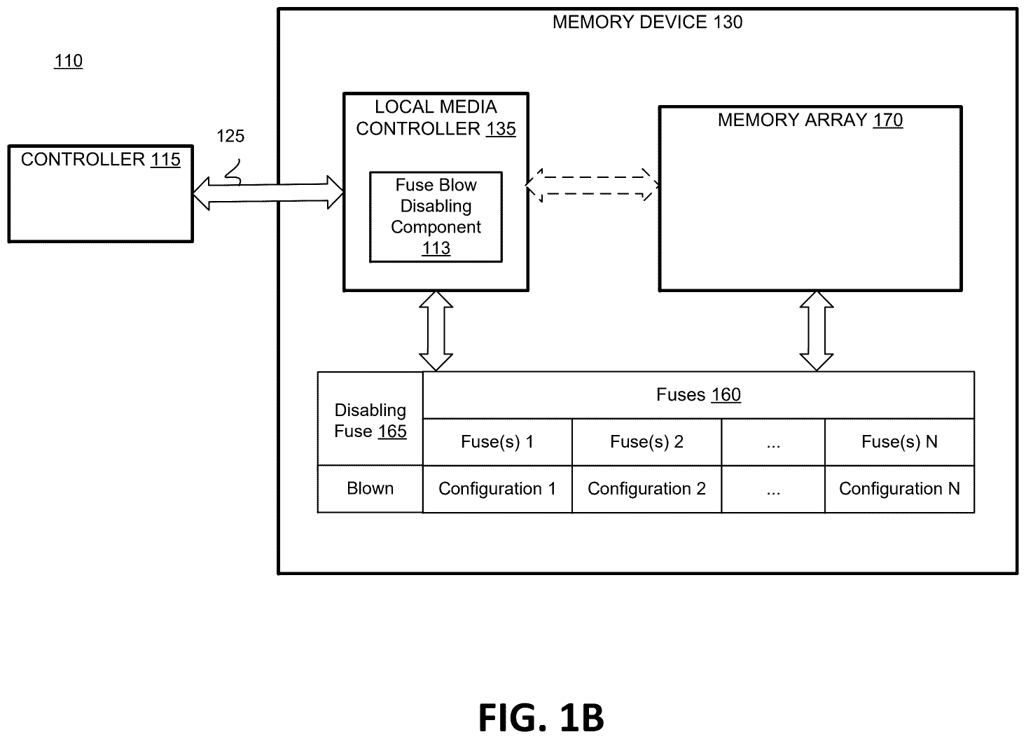

Aspects of the present disclosure are directed to memory device security through disablement of fuse blows. A memory sub-system can be a storage device, a memory module, or a hybrid of a storage device and memory module. Examples of storage devices and memory modules are described below in conjunction with FIG. 1A. In general, a host system can utilize a memory sub-system that includes one or more memory devices, such as memory devices that store data. The host system can provide data to be stored at the memory sub-system and can request data to be retrieved from the memory sub-system.

A memory device can be a non-volatile memory device. A non-volatile memory device is a package of one or more dice. Each die can include one or more planes. For some types of non-volatile memory devices (e.g., NAND devices), each plane consists of a set of physical blocks. For some memory devices, blocks are the smallest area that can be erased. Each block consists of a set of pages. Each page consists of a set of memory cells, which store bits of data.

In some cases, the memory device is manufactured with specific configurations under the control of the original manufacturer, but the supply chain for the memory device exhibits vulnerabilities, which can lead to the memory devices being modified without the knowledge of the original manufacturer. As portions of the manufacturing process, including test and assembly, are outsourced more often, the original manufacturers takes less control over the entire manufacturing process. As such, the original manufacturers demand better control over manufactured parts to defend against supply chain attacks. For example, a manufactured part may include a fuse identification (e.g., an electronic serial number). Modification of the fuse identification may keep the original manufacturers from tracking the party to which the manufactured part was sold, how the manufactured part was tested, or the product grade to which the manufactured part was assigned. When the manufactured part was suspected as experiencing unauthorized usage or sale, the modified fuse identification makes it impossible for the original manufacturers to track the origin of the manufactured part or an unauthorized up-sale. As another example, a manufactured part may include test keys, and modification of the test keys may make the manufactured part more suspectable to hacking (e.g., row hammer attacks).

Aspects of the present disclosure address the above and other deficiencies by implementing a disabling fuse to disable a blow functionality associated with a set of fuses in the memory device. Specifically, a set of decoding circuitry associated with the memory cells of the memory device may be programmed (e.g., via fuse, antifuse, or other programming techniques) to respond to configurations of the memory device, such as the fuse identification or test key (e.g., by controlling the internal voltage level) or to direct addresses attempting to access defected memory cells to a new portion of the memory device. The set of fuses may be set, during the manufacturing of the memory device, to correspond to the configurations of the memory device. To protect the manufactured parts from alteration by other parties in the supply chain and/or to trace such alteration, certain configuration of the memory device can be made unchangeable upon the original manufacture. In some cases, the set of fuses may be modified by a command performing a blow functionality associated with the set of fuses. The disabling fuse may be set, as the last step of manufacturing, to disable the blow functionality associated with the set of fuses, such that when the command performing the blow function is received, the set of fuses cannot be modified by a modification command.

To disable the blow functionality associated with the set of fuses, a decoding circuitry of the memory device may send a signal to blow the disable fuse. In some implementations, a command performing the blow function may result in a signal input to a blow fuse to blow the set of fuses. The blow fuse and the disable fuse may be connected to a Boolean logic AND gate such that when either the blow fuse or the disable fuse is blown, the output of the Boolean logic AND gate will be disabled to perform the blow functionality. In some embodiments, the disabling fuse may be implemented as an antifuse. In some embodiments, the disabling fuse may be implemented as multiple antifuses and a majority voting logic, where the majority voting logic may select, among multiple antifuses, one antifuse to be activated. This prevents the situation where one or more antifuses are malfunctioning.

Advantages of the present disclosure include protecting against bad actors modifying manufactured parts, including modification of fuse identification, test keys, etc. Aspects of the present disclosure also prevent security breaches on manufactured parts and the manufacturing of counterfeit parts. Specifically, locking the fuse states on manufactured parts enables anti-counterfeiting measures and guarantees performance. By disabling future blows via a fuse blow, the only way to re-enable blows would be opening the package of the manufactured parts and cutting metal lines, which would be easily identified by a visual inspection. Further, during operation of some memory devices, a post package repair (PPR) function can still be used to perform an operation similar to the fuse-blowing operation directed to certain fuses. Lastly, the cost of implementing the disabling fuse is minimal.

FIG. 1A illustrates an example computing environment 100 that includes a memory sub-system 110 in accordance with some embodiments of the present disclosure. The memory sub-system 110 can include media, such as memory devices 130 and 140 (also referred to as “memory devices”). The memory devices 130 and 140 can be volatile memory devices, non-volatile memory devices, or a combination of such. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing environment 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1A illustrates a memory sub-system 110 as an example. In general, the host system 120 can access multiple memory sub-systems via a same communication connection, multiple separate communication connections, and/or a combination of communication connections.

The memory devices 130 and 140 can include any combination of the different types of non-volatile memory devices and/or volatile memory devices. Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 and 140 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory devices such as NAND type flash memory are described, the memory devices 130 and 140 can be based on any other type of memory such as a volatile memory. In some embodiments, the memory devices 130 and 140 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

The memory system controller 115 (hereinafter referred to as “memory controller” or just “controller”) can communicate with the memory devices 130 and 140 to perform operations such as reading data, writing data, or erasing data at the memory devices 130 and 140 and other such operations. The controller 115 can include hardware such as one or more integrated circuits and/or discrete components, a buffer memory, or a combination thereof. The controller 115 can be a microcontroller, special purpose logic circuitry (e.g., a field programmable gate array (FPGA), an application specific integrated circuit (ASIC), etc.), or other suitable processor.

The controller 115 can include a processing device, which includes one or more processors (e.g., processor 117), configured to execute instructions stored in local memory 119. In the illustrated example, the local memory 119 of the controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, etc. The local memory 119 can also include read-only memory (ROM) for storing micro-code. While the example memory sub-system 110 in FIG. 1A has been illustrated as including the controller 115, in another embodiment of the present disclosure, a memory sub-system 110 cannot include a controller 115, and may instead rely upon external control (e.g., provided by an external host, or by a processor or controller separate from the memory sub-system).

In general, the controller 115 can receive commands or operations from the host system 120 and can convert the commands or operations into instructions or appropriate commands to achieve the desired access to the memory devices 130 and 140. The controller 115 can be responsible for other operations such as wear leveling operations, garbage collection operations, error detection and error-correcting code (ECC) operations, encryption operations, caching operations, and address translations between a logical address (e.g., logical block address (LBA)) and a physical address (e.g., physical block address) that are associated with the memory devices 130 and 140. The controller 115 can further include host interface circuitry to communicate with the host system 120 via the physical host interface. The host interface circuitry can convert the commands received from the host system into command instructions to access the memory devices 130 and 140 as well as convert responses associated with the memory devices 130 and 140 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the controller 115 and decode the address to access the memory devices 130 and 140. Any one of the memory devices 130 and 140 can include a media controller to manage the memory cells of the memory device 130 and 140, respectively, to communicate with the memory sub-system controller 115, and to execute memory requests (e.g., read or write) received from the memory sub-system controller 115.

In some embodiments, the memory devices 130 and 140 can be managed memory devices (e.g., managed NAND), which is a raw memory device combined with a local controller (e.g., media controller 130) for memory management within the same memory device package. In some embodiments, the memory device 130 can include a fuse blow disabling component 113 that can be used to disable fuse blows. In some embodiments, the media controller 135 includes at least a portion of the fuse blow disabling component 113. In some embodiments, the fuse blow disabling component 113 is part of an application, or an operating system.

The fuse blow disabling component 113 can receive a signal to disable a blow functionality associated with one or more fuses of the memory device 130 of the memory sub-system 110. The fuse blow disabling component 113 can, in response, a command to make a disabling fuse blown such that the associated fuses of the memory device 130 cannot be blown anymore. Further details with regards to the operations of fuse blow disabling component 113 are described below.

FIG. 1B is a block diagram of the memory sub-system 110 of FIG. 1A in accordance with some embodiments of the present disclosure. In embodiments, the memory sub-system 110 includes the controller 115 coupled to the memory device 130, which is depicted as an example memory device. The memory device 130 can include a local media controller 135, a memory array 170, a disabling fuse 165, and multiple additional fuses 160. The local media controller 135 can couple the controller 115, the memory array 170, and the multiple fuses 160 together as illustrated.

In one embodiment, the local media controller 135 is coupled to the controller 115 via an interface 125 (e.g., open NAND flash interface (ONFI), which is the communication interface between an SSD controller and a NAND component of memory). Further, in some embodiments, the local media controller 135 is a microcontroller that includes a hardware state machine that translates commands from the interface 125 (as sent by the controller 115) to access the memory array 170. For example, the local media controller 135 can include control logic embodied as the state machine that can be generally unchangeable and that executes the commands or operations as directed by the controller 115. In one embodiment, the memory array 170 is an array of multiple blocks (e.g., numbered zero through N) that can be indexed within a logical-to-physical address mapping of logical addresses (e.g., assigned by the controller 115 or the host system 120) to physical addresses (e.g., an indexed value within the memory array 170). For example, the local media controller 135 can update the mapping for a block (of the multiple blocks) by programming a field of the logical-to-physical address mapping with a different value.

In some embodiments, each of the fuses 160 include a hardware fuse that can be triggered to be blown by the local media controller 135. The local media controller 135 may perform the fuse-blowing operation on one or more fuses of the fuses 160, such that the fuses 160 are blown and the blown fuse 160 maintain the configurations as set. In some embodiments, respective fuses of the multiple fuses 160 are operatively coupled to the local media controller 135 to correspond to various configurations (e.g., fuse identification of a device, test keys, etc.) of the memory device 130. In some embodiments, respective fuses of the multiple fuses 160 are operatively coupled between respective blocks and the local media controller 135 such that when a fuse is blown, the data within the block previously coupled to the fuse is both physically and electrically unchangeable. In additional or alternative embodiments, the control logic of the local media controller 135 can be designed to check the status (e.g., fuse state) of a fuse.

In some embodiments, the disabling fuse 165 includes a hardware fuse that can be triggered to be blown by the fuse blow disabling component 113 to disable a blow functionality associated with the fuses 160. The fuse blow disabling component 113 can send an enable signal for blowing the disabling fuse 165 to perform the fuse-blowing operation on the disabling fuse 165, such that the fuses 160 cannot be blown through a command performing the blow functionality. Specifically, the local media controller 135 may perform the fuse-blowing operation on one or more fuses of the fuses 160 by using a blowing command, i.e., a command performing the blow functionality (e.g., AFPROG command). Upon the fabrication and testing that all configuration (including the fuses 160) has been setup, the fuse blow disabling component 113 may send the enable signal for blowing the disabling fuse 165. As a result, the fuses 160 cannot be blown through the command performing the blow functionality (e.g., AFPROG command).

In one embodiment, the disabling fuse 165 and/or each of the fuses 160 may be a laser-fusible link that is typically composed of polysilicon or metal and is covered by a uniform layer of dielectric, such as silicon dioxide.

In some embodiments, the disabling fuse 165 may be implemented as an antifuse. In some embodiments, the disabling fuse 165 may be implemented as multiple antifuses and a majority voting logic. The majority voting logic may select, among multiple antifuses, one antifuse to be activated. This can also prevent the situation that one or more antifuses are malfunctioning. For example, the majority voting logic may be a Boolean logic performing an OR operation such that when any one of the antifuses is blown, the output of the majority voting logic is to blow. In some embodiments, blowing the disabling fuse 165 may involve blowing a plurality of antifuses and using a majority voting logic to select one antifuse from the plurality of antifuses to represent a state (e.g., blown or not blown) of the disabling fuse 165.

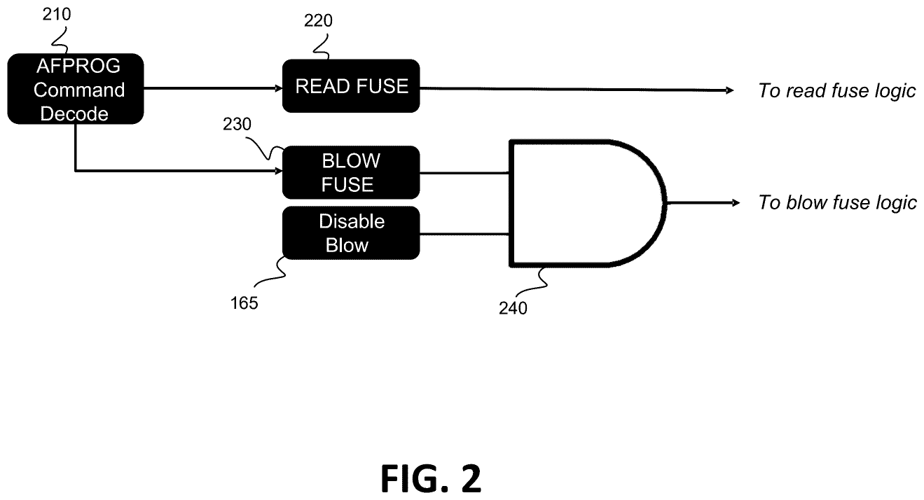

FIG. 2 illustrates an example of a command (e.g., received by the local media controller 135) performing the blow functionality and the disablement of the blow functionality. A decoding circuitry 210 (e.g., located in the local media controller 135) may receive commands associated with fuses, such as fuses 160. For example, the commands may include a command reading the status of the fuses 160 and/or a command performing the blow functionality of the fuses 160. In some implementations, the decoding circuitry 210 may receive the command reading the status of the fuses and send a read-fuse enabling signal 220 to read the status of the fuses. The read-fuse enabling signal 220 may be provided by an internal/manufacturer use only command to access a specific address of a fuse in the fuse array and provide the fuse state (i.e., data read). This is used to ensure fuse blows were successful in manufacturing or to read out part of settings during postproduction. In some implementations, the decoding circuitry 210 may receive the command performing the blow functionality and send a blow-fuse enabling signal 230 to blow the fuses. The blow-fuse enabling signal 230 may be provided by an internal/manufacturer use only command to change the state of a specific hardware fuse in the address of the fuse or antifuse array. This is used in manufacturing to tune the performance of the memory device or adjust various on-die voltage/timing/repair settings.

The fuse blow disabling component 113 may blow the disable fuse 165 to disable the blow functionality. For example, the blow-fuse enabling signal 230 and the state of the disable fuse 165 may be connected to a Boolean logic AND gate 240 such that when blow-fuse enabling signal 230 is active (“0”) or the disable fuse 165 is blown (“0”), the output of the Boolean logic AND gate 240 will disable (“0”) the blow functionality of fuses 160. Specifically, when blow-fuse enabling signal 230 is active (“0”) and the disable fuse 165 is blown (“0”), the output of the Boolean logic AND gate 240 will disable (“0”) the blow functionality of fuses 160; when blow-fuse enabling signal 230 is active (“0”) and the disable fuse 165 is not blown (“1”), the output of the Boolean logic AND gate 240 will disable (“0”) the blow functionality of fuses 160; when blow-fuse enabling signal 230 is inactive (“1”) and the disable fuse 165 is blown (“0”), the output of the Boolean logic AND gate 240 will disable (“0”) the blow functionality of fuses 160; when blow-fuse enabling signal 230 is inactive (“1”) and the disable fuse 165 is not blown (“1”), the output of the Boolean logic AND gate 240 will enable (“0”) the blow functionality of fuses 160.

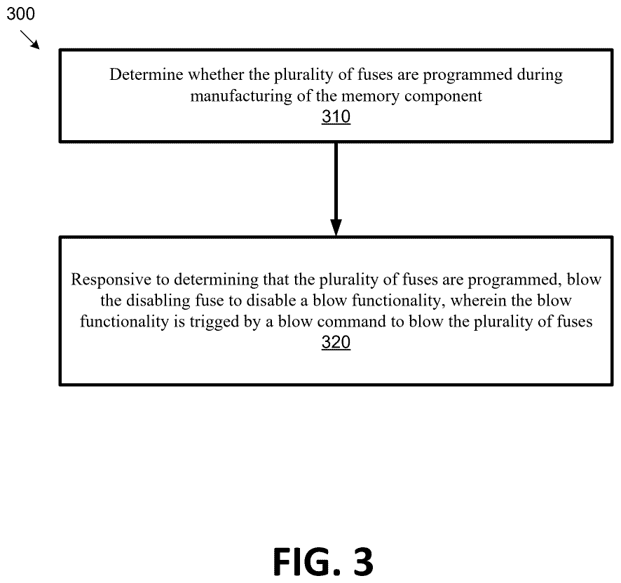

FIG. 3 is a flow diagram of an example method 300 to implement, during the manufacture of the memory device, the disablement of fuse blows in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the fuse blow disabling component 113 and/or the local media controller 135 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 310, the processing logic determines whether the plurality of fuses are programmed during manufacturing the memory device (e.g., memory device 130). In some implementations, the processing logic may determine a fuse has been programmed by reading a value of a fuse according to an address of the fuse and determining that the value matches a preset value. In some implementations, the plurality of fuses comprises one or more fuses that are programmed to generate a fuse identifier of the memory device. In some implementations, the plurality of fuses comprises one or more fuses that are programmed to generate one or more test keys of the memory device. In some implementations, the plurality of fuses comprises one or more fuses that are programmed to repair one or more addresses of the memory device.

At operation 320, responsive to determining that the plurality of fuses are programmed during manufacturing the memory device, the processing logic sends a signal for blowing the disabling fuse to disable a blow functionality, wherein the blow functionality is trigged by a subsequent blow command to blow the plurality of fuses. In some implementations, the disabling fuse comprises at least one of: an electronic fuse, or an antifuse. In some implementations, the processing logic may blow a plurality of antifuses and use a majority voting logic to select one antifuse from the plurality of antifuses to represent a state of the disabling fuse. In some implementations, the processing logic may blow a plurality of electronic fuses and use a majority voting logic to select one electronic fuse from the plurality of electronic fuses to represent a state of the disabling fuse. In some implementations, the processing logic may blow a plurality of electronic fuses and antifuses (e.g., multiple electronic fuses and one antifuse, one electronic fuse and multiple antifuses, or multiple electronic fuses and multiple antifuses) and use a majority voting logic to select one electronic fuse or antifuse from the plurality of electronic fuses and antifuses to represent a state of the disabling fuse. In some implementations, blowing the disabling fuse is performed as a last step of the manufacturing of the memory device. In some implementations, the processing logic may receive the subsequent blow command, determine that the disabling fuse is blown, and output, through a Boolean logic gate, a value to disable the blow functionality, wherein a signal from the subsequent blow command and a signal via the disabling fuse are input to Boolean logic gate. In some implementations, the Boolean logic gate may comprise a Boolean logic AND gate.

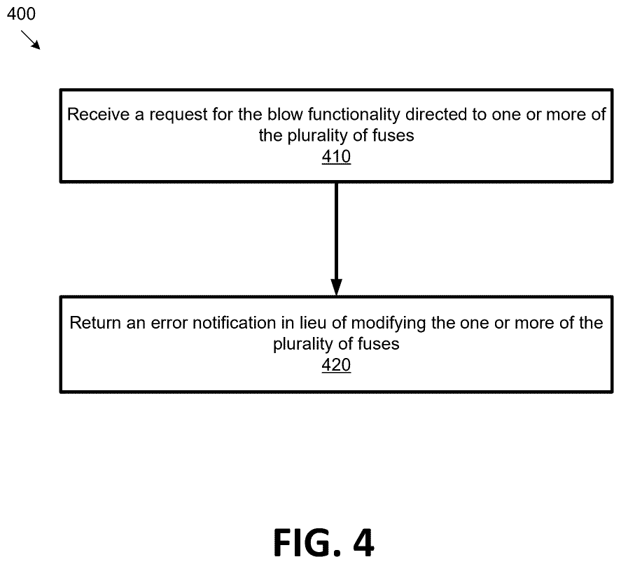

FIG. 4 is a flow diagram of an example method 400 to implement, during the operation of the memory device, the disablement of fuse blows in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the fuse blow disabling component 113 and/or the local media controller 135 of FIGS. 1A-1B. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic receives, during the operation of the memory device, a subsequent blow command for the blow functionality directed to one or more of the plurality of fuses. In some implementations, at operation 420, in response to receiving the subsequent blow command during the operation of the memory device, the processing logic sends an error notification, to the system that sends the subsequent blow command, instead of modifying one or more of the plurality of fuses. In some implementations, at operation 420, in response to receiving the subsequent blow command during the operation of the memory device, the processing device ignores the subsequent blow command without sending any error notification. In some implementations, the processing logic may determine that the disabling fuse is blown, and output, through a Boolean logic gate, a value to disable the blow functionality, wherein a signal from the subsequent blow command and a signal via the disabling fuse are input to Boolean logic gate. In some implementations, the Boolean logic gate may comprise a Boolean logic AND gate. In some implementations, the processing logic may receive, during the operation of the memory device, a command of a post package repair (PPR) function, wherein the PPR function is directed to one or more fuses of the plurality of fuses, and perform the PPR function on the one or more fuses of the plurality of fuses.

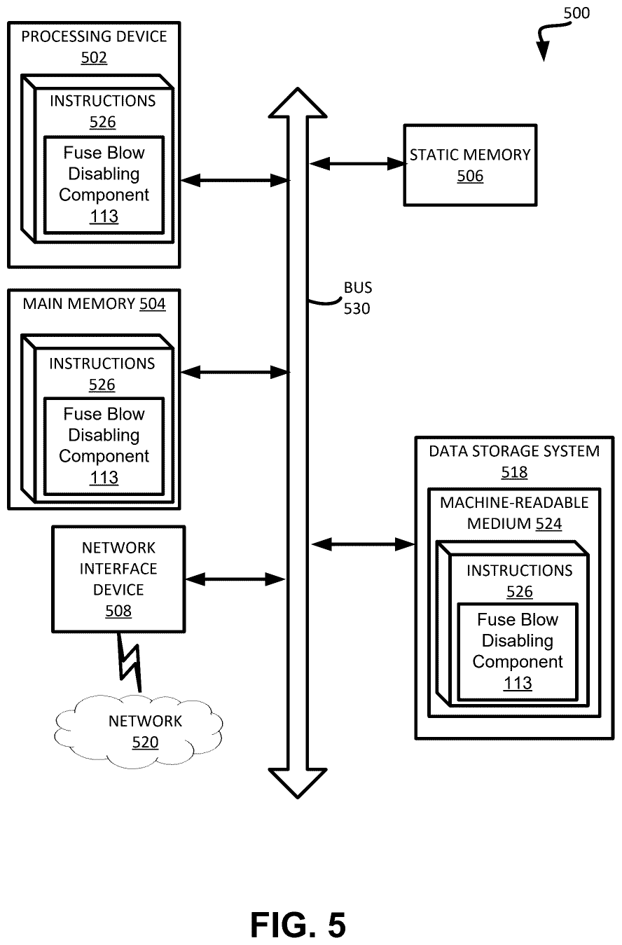

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1A) that includes, is coupled to, or utilizes a memory sub-system (e.g., the memory sub-system 110 of FIGS. 1A-1B) or can be used to perform the operations of a controller 115 (e.g., to execute an operating system to perform operations corresponding to the fuse blow disabling component 113 of FIG. 1A). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIGS. 1A-1B.

In one embodiment, the instructions 526 include instructions to implement functionality corresponding to an error determining component (e.g., the error determining component 113 of FIG. 1A) or firmware of the local media controller 135. While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory device comprising:
a memory array;
a plurality of fuses;
a disabling fuse; and
control logic, operatively coupled with the plurality of fuses and the disabling fuse, to perform operations during manufacturing of the memory device, the operations comprising:
determining whether the plurality of fuses are programmed; and
responsive to determining that the plurality of fuses are programmed, blowing the disabling fuse to disable a blow functionality, wherein the blow functionality is triggered by a subsequent blow command to blow the plurality of fuses.

2. The memory device of claim 1, wherein the disabling fuse comprises at least one of: an electronic fuse, or an antifuse.

3. The memory device of claim 1, wherein blowing the disabling fuse further comprises at least one of: blowing a plurality of antifuses and using a majority voting logic to select one antifuse from the plurality of antifuses to represent a state of the disabling fuse, or blowing a plurality of electronic fuses and using a majority voting logic to select one electronic fuse from the plurality of electronic fuses to represent a state of the disabling fuse.

4. The memory device of claim 1, wherein the plurality of fuses comprises one or more fuses that are programmed to generate a fuse identifier of the memory device.

5. The memory device of claim 1, wherein the plurality of fuses comprises one or more fuses that are programmed to generate one or more test keys of the memory device.

6. The memory device of claim 1, wherein the plurality of fuses comprises one or more fuses that are programmed to repair one or more addresses of the memory device.

7. The memory device of claim 1, wherein blowing the disabling fuse is performed as a last step of the manufacturing of the memory device.

8. The memory device of claim 1, wherein the operations further comprise:
receiving the subsequent blow command;
determining that the disabling fuse is blown; and
outputting, via a Boolean logic gate, a value to disable the blow functionality.

9. The memory device of claim 8, wherein the operations further comprise:
sending an error notification in response to receiving the subsequent blow command, wherein the subsequent blow command is received during operation of the memory device.

10. The memory device of claim 1, wherein the operation further comprises:
receiving a command of a post package repair (PPR) function, wherein the PPR function is directed to one or more fuses of the plurality of fuses; and
performing the PPR function on the one or more fuses of the plurality of fuses.

11. The memory device of claim 1, wherein determining that the plurality of fuses are programmed further comprises:
reading a value of a fuse of the plurality of fuses according to an address of the fuse; and
determining that the value matches a preset value.

12. A method comprising:
determining, by a control logic of a memory device, whether a plurality of fuses are programmed during manufacturing of the memory device, wherein the memory device comprises the plurality of fuses and a disabling fuse; and
responsive to determining that the plurality of fuses are programmed, blowing the disabling fuse to disable a blow functionality, wherein the blow functionality is triggered by a subsequent blow command to blow the plurality of fuses.

13. The method of claim 12, wherein the disabling fuse comprises at least one of: an electronic fuse, or an antifuse.

14. The method of claim 12, wherein blowing the disabling fuse further comprises at least one of: blowing a plurality of antifuses and using a majority voting logic to select one antifuse from the plurality of antifuses to represent a state of the disabling fuse, or blowing a plurality of electronic fuses and using a majority voting logic to select one electronic fuse from the plurality of electronic fuses to represent a state of the disabling fuse.

15. The method of claim 12, wherein the plurality of fuses comprises one or more fuses that are programmed to at least one of: generate a fuse identifier of the memory device, generate one or more test keys of the memory device, or repair one or more addresses of the memory device.

16. The method of claim 12, further comprising:
receiving the subsequent blow command;
determining that the disabling fuse is blown; and
outputting, via a Boolean logic gate, a value to disable the blow functionality.

17. A non-transitory computer-readable storage medium comprising instructions that, when executed by a processing device, cause the processing device to perform operations comprising:
determining, by a control logic of a memory device, whether a plurality of fuses are programmed during manufacturing of the memory device, wherein the memory device comprises the plurality of fuses and a disabling fuse; and
responsive to determining that the plurality of fuses are programmed, blowing the disabling fuse to disable a blow functionality, wherein the blow functionality is triggered by a subsequent blow command to blow the plurality of fuses.

18. The non-transitory computer-readable storage medium of claim 17, wherein the disabling fuse comprises at least one of: an electronic fuse, or an antifuse.

19. The non-transitory computer-readable storage medium of claim 17, wherein blowing the disabling fuse further comprises at least one of: blowing a plurality of antifuses and using a majority voting logic to select one antifuse from the plurality of antifuses to represent a state of the disabling fuse, or blowing a plurality of electronic fuses and using a majority voting logic to select one electronic fuse from the plurality of electronic fuses to represent a state of the disabling fuse.

20. The non-transitory computer-readable storage medium of claim 17, wherein the operations further comprise:
receiving the subsequent blow command;
determining that the disabling fuse is blown; and
outputting, via a Boolean logic gate, a value to disable the blow functionality.
